(19) United States
(12) Patent Application Publication
(10) Pub. No.: US 2008/0005879 A1
(43) Pub. Date: Jan. 10, 2008

(54) METHOD FOR RELEASABLY HOLDING TWO ARTICLES TOGETHER

(75) Inventor: Per-Erik Cardell, Linkoping (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SAAB AB, Linkoping (SE)

(21) Appl. No.: 11/773,416

(22) Filed: Jul. 4, 2007

Related U.S. Application Data
(62) Division of application No. 11/161,085, filed on Jul. 22, 2005.

(30) Foreign Application Priority Data
Aug. 6, 2004 (EP) 04018661.1

(51) Int. Cl. F16B 5/00

(52) U.S. Cl. 29/281.5

(57) ABSTRACT

A method for releasably holding two machined articles (1, 2) together in a mutually fixed position comprises lugs (6, 9) with openings having surfaces to be aligned with each other for defining said fixed position with respect to two dimensions and surfaces arranged to bear against each other for defining said position in a third dimension. The method further comprises inserting a tool (20) through the openings of adjacent lugs and pressing them into said alignment and said surfaces to bear under pretension against each other for holding the articles in a mutually fixed position.

The present application is divisional patent application claiming the benefit of U.S. Ser. No. 11/161085, Publication No. US-2006-0029464, filed on 22 Jul. 2005.

### TECHNICAL FIELD OF THE INVENTION

The present invention relates to a method for releasably holding two articles together in a mutually fixed position. More particularly, the invention relates to a method that enables the articles to be held together very precisely in mutually fixed positions.

### BACKGROUND OF THE INVENTION

The articles that require holding together may be any type of articles to be held together in a mutually fixed position with a high accuracy most often for being permanently secured to each other in this position. However, it is also possible that the articles are only held together in said position for being treated in any way, such as through drilling, punching, broaching, sawing or the like in this position.

Such method is for instance of great interest and used for holding two articles together in a mutually fixed position when assembling such articles to form an airplane fuselage, and this particular field of use of the present invention will hereinafter be discussed for illuminating the invention and the problems to be solved thereby without for that sake limiting the invention to this field of use.

Very complicated and costly jigs are presently used for assembling each larger article in an airplane fuselage, where the jigs control the position of each such article. The articles to be held together in a mutually fixed position are to be mounted in the jigs through a number of securing elements, inserts and connecting means. These jigs are then brought to move the articles together and hold them in a mutually fixed position. While held in this position the articles are machined through drilling, broaching and the like, whereupon they are removed from the jigs for intermediate burring, washing and application of sealing means. The articles are after that once again mounted in the jigs and brought to said mutually fixed position for being permanently secured to each other by riveting. Such removal for intermediate burring, washing and application of sealing means is necessary, since drillings and the like is introduced in spaces between the two articles when they are machined, and such particles have to be removed before permanently securing the articles to each other.

The costs for such complicated jigs, the costs for maintenance of the equipment and calibration of the jigs as well as the way to proceed for assembling the articles while using these jigs are comparatively high.

### SUMMARY OF THE INVENTION

The object of the present invention is to provide a method at least partially solving the problems mentioned above.

This object is according to the invention obtained by providing a method A method for releasably securing first and second machined articles in a mutually fixed position to each other, comprising:

providing said first machined article with a first lug having a first lug opening,

providing said first machined article with a lug receiving aperture,

providing said second machined article with a second lug with a second lug opening, at least one of said first and second lug openings being surroundingly limited by lug portion walls,

Inserting the second lug of the second machined article through said lug receiving aperture in said first article, so that the first and second lug openings of said first and second lugs are at least partially overlapping, and so that a surface surrounding said first lug opening is facing a surface surrounding said second lug opening,

inserting a tool through said first and second lug openings of adjacent lug portions, pressing at least two interior surfaces of the first lug opening into alignment with at least two corresponding interior surfaces of the second lug opening, thereby defining said fixed position in two dimensions

pressing and holding holding under tension said surface surrounding said first lug opening against said surface surrounding said second lug opening to define said fixed position with respect to a third dimension, for holding the articles in a mutually fixed position.

By using machined articles, i.e. articles formed by machining of one single material piece, normally primarily through milling, as said articles said lug portions with openings and the opening in the first article may be very exactly applied, so that it is possible to hold the articles together in a mutually fixed position very exactly and tightly by using said tool. This results in a number of advantages. Only very simple and by that less costly jigs are necessary for keeping the articles in place when assembling them. The number of inserts, connecting means and fastening elements is reduced. The time for assembling in jigs is substantially reduced, especially since the machine articles may be held that tightly in said mutually fixed position that no drillings or the like will enter any space between the articles, since such spaces are not there, and there is accordingly no need to remove the articles from the jigs after drilling and the like for burring, washing and application of sealing means, but the articles may be held together in a mutually fixed position throughout the assembling procedure.

According to an embodiment of the invention only one of said two lug portions having delimiting surfaces to be moved into alignment has an opening surroundingly delimited by lug portion walls and the opening of the other lug portion is laterally opened in the direction away from said first article in said fixed position and by that groove-like. It is often easier to obtain such a groove-like opening in a lug portion than an opening having surrounding delimiting walls, and it has been found out that one of the openings may be of that type, which will save time and costs.

According to another embodiment of the invention said first lug portion has a said groove-like opening. This is mostly preferred, since it is mostly easier to obtain an opening having surrounding delimiting walls in a lug portion projecting from an article for being able to be introduced through an opening in the other article as is the case for said second lug portion. Said second lug portion is namely normally located at an edge of an article in the form of a plate-like member, whereas the first lug portion is normally located close to an opening through the large side of such a plate-like member.

According to another embodiment of the invention said tool has a wedge-like character so as to by wedge action obtain said pressing into alignment of said delimiting surfaces to each other in said fixed position. By using a wedge action in combination with said lug portions of the two machine articles the machine articles may be held with a high accuracy and very tightly in a mutually fixed position.

According to another embodiment of the invention the tool has a wedge-shaped part adapted to have the most narrow end thereof firstly introduced through said two openings of adjacent lug portions, and the tool comprises means for engagement with the most narrow end of the wedge-shaped part for applying a force thereon for pressing this part in the direction of said introduction. This results in a possibility to very exactly press said lug portions into an exact alignment of said defining surfaces thereof for exactly define said fixed position with respect to two dimensions.

According to another embodiment of the invention the tool further comprises a member to be engaged with a thicker end of the wedge-shaped part not possible to be brought through the openings of the lug portions so as to apply forces on the wedge-shaped part in the opposite direction to the direction of introduction and by that press said surrounding surfaces of the two lug portions to bear against each other. This results in a very exact definition of said fixed position with respect to said third dimension.

Said engagements are preferably obtained by threaded bores in the wedge-shaped part and threaded male members, such as screws, tightened against spacers arranged on the respective lug portion.

According to another embodiment of the invention the tool has a wedge-shaped part to be introduced through the two openings of two adjacent lug portions in the direction of the narrowest end thereof, and the wedge-shaped part has a substantially rectangular cross-section as seen in the direction of the introduction intended. A wedge-shaped part of this design allows an accurate definition of the fixed position, and this is especially the case when two adjacent sides of the wedge-shaped part converges towards the respective opposite side in the direction towards the most narrow end of said part, while the other adjacent sides thereof extends substantially in parallel with said direction, and two adjacent said sides delimiting surfaces of each opening in said lug portions are correspondingly inclined for tightly bearing against the two sides first mentioned of the wedge-shaped part. In the case of a groove-like opening in one of the lug portions one of said two other sides of the wedge-shaped part has to co-operate with the “bottom” of said groove.

According to another embodiment of the invention the device has means adapted to fix the two articles with respect to each other on a location at a distance from said tool for preventing the articles held together to rotate about said tool, and this fixing means may then comprise a further said tool adapted to co-operate in the same way as the tool first mentioned with lug portions and openings of the articles on said location. However, in such a case said further tool may be slightly simplified with respect to the tool first mentioned, since it should mostly only have to fix the two articles with respect to each other in one or two dimensions.

The features and the advantages of the method for releasably securing two articles in a mutually fixed position to each other according to the invention appear from the discussion above.

The invention also relates to a method for permanently securing at least two articles to each other, in which the articles are brought into a mutually fixed position and are while holding them in this position permanently secured to each other according to the corresponding appended claim. Also the features and advantages thereof appear from the discussion above of the device according to the invention.

Further advantages as well as advantageous features of the invention will appear from the following description and the other dependent claims.

### BRIEF DESCRIPTION OF THE DRAWINGS

With reference to the appended drawings, below follows a specific description of an embodiment of the invention cited as an example.

In the drawings:

FIG. 1 is a perspective view of a part of a machine article in the form of a rib for an airplane fuselage with an opening and a lug portion with opening and bearing surfaces of a device according to the present invention,

FIG. 2 is a perspective view of a part of a wall to be placed between and secured to such ribs and which is provided with a lug portion with opening of the device according to the invention,

FIG. 3 is an exploded view of a tool being a part of a device according to the invention,

FIG. 4 is a front view of a wedge-shaped part of the tool shown in FIG. 3,

FIG. 5 is a view illustrating the procedure of securing the rib of FIG. 1 to the wall of FIG. 2 in accordance with the present invention, and

FIG. 6 is a perspective view illustrating a rear rib of an airplane fuselage according to FIG. 1 held in a fixed position with respect to a wall according to FIG. 2 connecting it to another rib.

### DETAILED DESCRIPTION OF AN EMBODIMENT OF THE INVENTION

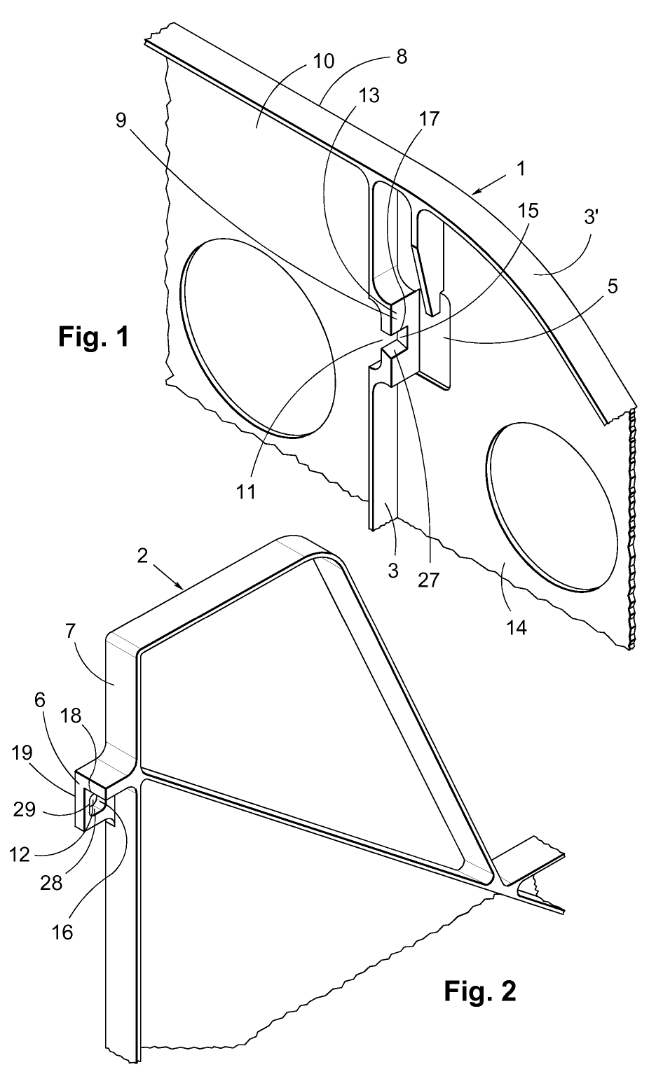

FIG. 1 shows a part of a rear rib 1 of an airplane fuselage in the form of a first machine article to be secured to another, second machine article 2 in the form of an intermediate wall shown in FIG. 2. The different members, such as reinforcing flanges 3, 3′ and a lug portion 9, have been obtained from a single material piece through machining, here milling. This results in very small tolerances of the dimensions of these members.

A device for releasably holding the two machine articles 1, 2 together in a mutually fixed position comprises a first opening 5 in the first machine article 1 through which a second lug portion 6 projecting from an end surface 7 of the second article 2 is designed to be moved from a first side 8 of the first article, so that this end surface 7 bears tightly against said first side 8. The first article has a first projecting lug portion 9 arranged on the opposite second side 10 of the first article adjacent to said first opening 5.

The two lug portions have an opening 11, 12 each passing there-through transversely to said first opening 5 when the second lug portion 6 is introduced through this opening. The opening 12 in the second lug portion is surroundingly delimited by lug portion walls, whereas the opening 11 of the first lug portion 9 is laterally opened in the direction away from the first article and by that groove-like. It is necessary that one of the two openings has surroundingly delimiting walls, and it is easier to accomplish this in the lug portion on the end surface than the lug portion arranged on a large surface of an article. Both lug portion openings may of course have surroundingly delimiting walls when desired.

The two lug portions are arranged to be located with their openings at least partially overlapping when the second lug portion 6 is introduced through said first opening 5. Furthermore, the respective lug portion opening is designed to have at least two surfaces defining it in alignment with corresponding surfaces defining the lug portion opening of the adjacent lug portion for defining said fixed position with respect to two dimensions, namely in a plane parallel to surfaces 13 surrounding the opening 11 of the first lug portion 9 and here being perpendicular to the large surface 14 of the first article. Said surfaces to be in alignment are the bottom surface 15 of the opening 11 in the first lug portion 9, the corresponding surface 16 in the second lug portion 6 and one surface 17, 18 of each of these openings perpendicular thereto, in this case the upper surfaces as seen in FIGS. 1 and 2.

The definition of said fixed position with respect to a third dimension is obtained by tightly bearing of the surfaces 13 surrounding the opening 11 against surfaces 19 surrounding the opening 12 of the second lug portion when this is introduced through the first opening 5.

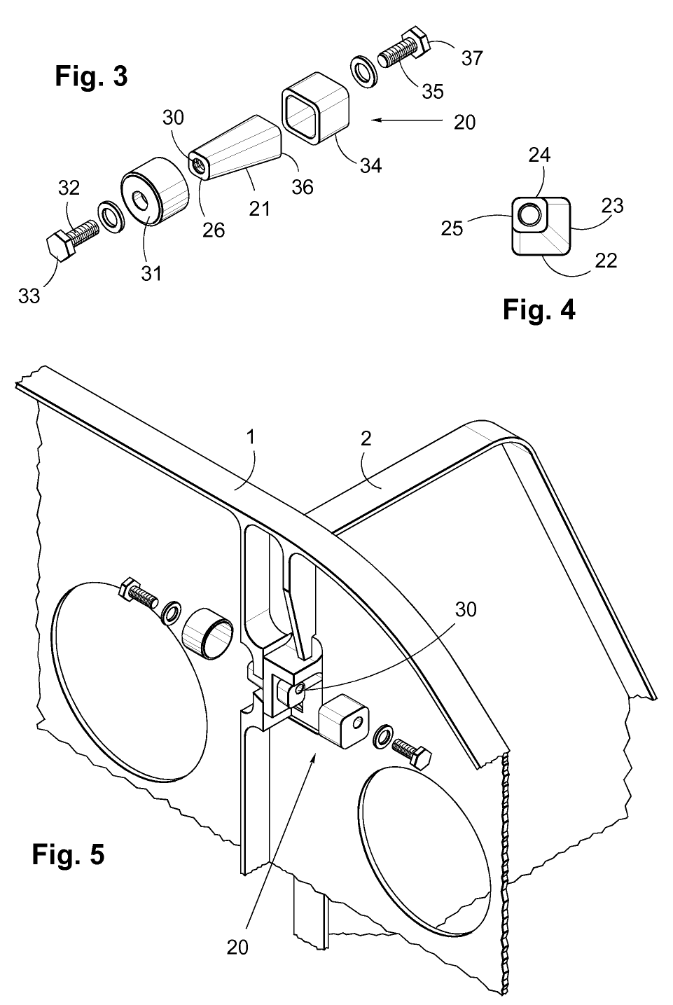

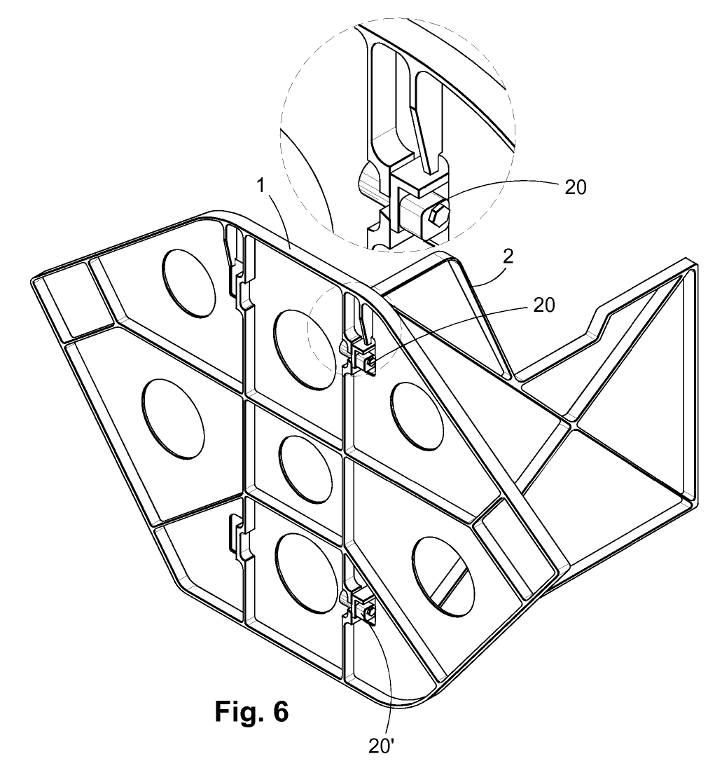

The device also comprises a tool 20 illustrated in FIGS. 3 and 4 adapted to hold the articles together in said mutually fixed position. How this is obtained is illustrated in FIG. 5. The tool has a wedge-shaped part 21 adapted to be introduced through the openings 11, 12 of adjacent lug portions 6, 9 and press them into alignment of said defining surfaces 15, 16 and 17, 18 and said surrounding surfaces 13, 19 to bear under pretension against each other for holding the articles in a mutually fixed position. The wedge-shaped part 21 has a rectangular cross-section, in this case a square cross-section, with two adjacent sides 22, 23 converging towards the respective opposite side 24, 25 in the direction towards the narrowest end 26 of this part 21. The other adjacent sides 24, 25 extend substantially in parallel with said direction. Corresponding surfaces of the openings in the lug portions are correspondingly inclined, which in this case is the lower surface 27 of the first lug portion 9 and the lower surface 28 and the surface 29 opposite to the surface 16 of the second lug portion 6.

The wedge-shaped part 21 has a threaded bore 30 extending therethrough. A first spacer 31 in the form of a sleeve is adapted to be applied upon the first lug portion around said most narrow end 26 of the wedge-shaped part when this is introduced through the lug portion openings and to be tightened against this lug portion by tightening a head 33 of a screw 32 engaging the bore 30 thereagainst. By tightening said screw 32 the wedge-shaped part is forced further through the openings 11, 12 of the lug portions for pressing the lug portions to a very exact alignment of said opening surfaces thereof and by that definition of said mutually fixed position in two dimensions.

The tool also comprises a second spacer 34 also having a sleeve-like character to be applied on the second lug portion and tightened thereagainst by a screw 35 engaging the threaded bore 30 from the thicker end 36 of the wedge-shaped part 21 with the head 37 of the screw against the spacer. By tightening the screw 35 the wedge-shaped part will be influenced in the direction out of the openings 11, 12 of the lug portions and the surrounding surfaces 13, 19 of these openings will by that be pressed against each other for defining said fixed position in a third dimension perpendicular to the first two dimensions.

The fixing of the two articles 1, 2 in said mutually fixed position will take place in the following way. The second lug portion 6 is firstly introduced through the first opening 5 of the first article 1, so that the openings 11, 12 of the lug portions will overlap. The wedge-shaped part 21 is then introduced with the narrowest end 26 first through the two openings of the lug portions as shown in FIG. 5. The first spacer 31 is after that applied onto the first lug portion and the screw 32 introduced therethrough and through the bore 30 and tightened so as to pull the wedge-shaped part 21 as much as possible through said openings of the lug portions for defining said fixed position into dimensions perpendicular to the direction of introduction of the wedge-shaped part. The second spacer 34 is after that applied on the second lug portion and the screw 35 is introduced therethrough and through the bore 30 and tightened for pressing the surfaces 13 and 19 of the lug portions against each other for defining said fixed position in a third dimension corresponding to the direction of said introduction.

It is shown in FIG. 6 how the device also comprises means adapted to fix the two articles with respect to each other on a location at a distance from said tool, and this means is in this case a further such tool 20′. This tool 20′ has only to fix the articles in two dimensions, namely in the direction of said introduction of the wedge-shaped part and in the direction of introduction of the second lug portion in the first opening of the first article. This means that the articles are prevented from rotating about the first tool 20.

A number of such articles may in this way be mutually fixed and then in said fixed state be subjected to for instance drilling or broaching, application of sealing means and the like. The articles may then, still held in this state, be permanently secured to each other through for example riveting. Said tools 20, 20′ will after that be removed for being used when fixing other articles to each other.

The invention is not restricted to the embodiment shown in the figures and described above.

The wedge-shaped part may for instance have another cross-section than that shown and the surfaces of the lug portion openings to be aligned be otherwise directed than shown.

The inclined surfaces of the lug portion openings may be inclined in the other direction and the wedge-shaped part be introduced firstly through the first lug portion and then through the second lug portion. Thus, the first spacer will then bear against the second lug portion and the second against the first.

1. A method for releasably securing first and second machined articles in a mutually fixed position to each other, comprising:
a) Providing said first machined article with a first lug having a first lug opening,
b) Providing said first machined article with a lug receiving aperture,
c) Providing said second machined article with a second lug with a second lug opening, at least one of said first and second lug openings being surroundingly limited by lug portion walls,
d) Inserting the second lug of the second machined article through said lug receiving aperture in said first article, so that the first and second lug openings of said first and second lugs are at least partially overlapping, and so that a surface surrounding said first lug opening is facing a surface surrounding said second lug opening,
e) Inserting a tool through said first and second lug openings of adjacent lug portions, pressing at least two interior surfaces of the first lug opening into alignment with at least two corresponding interior surfaces of the second lug opening, thereby defining said fixed position in two dimensions
f) Pressing and holding under tension said surface surrounding said first lug opening against said surface surrounding said second lug opening to define said fixed position with respect to a third dimension, for holding the articles in a mutually fixed position.

2. Method according to claim 1, further comprising the step of permanently securing the articles in their mutually fixed position, by riveting for example.

3. Method according to claim 2, further comprising the step of machining to remove material from the articles, by drilling or broaching for example, prior to the step of permanently securing the articles in their mutually fixed position.

4. Method according to claim 1, wherein, in step e) said tool has a tapered part and is inserted with the narrower end of said part first through the first and second lug openings of adjacent first and second lug portions, a first headed screw is then screwed into a first threaded bore in the most narrow end of said tapered part from the opposite direction and is tightened with its head against a spacer defining a minimum distance of said head to one of said first and second lugs so as to pull the tapered part further through said openings, a second headed screw is after that inserted into a second threaded bore in the thicker end of the tapered part for being tightened with its head against a spacer defining a minimum distance of said head to the other of the first and second lugs for acting upon the tapered part in the direction out of the openings and by that press said surrounding surfaces of the lugs against each other.

5. Method according to claim 1, wherein the method is carried out for securing articles of an airplane fuselage in a mutually fixed position.
